(19) United States
(12) Patent Application Publication
(10) Pub. No.: US 2008/0190157 A1
(43) Pub. Date: Aug. 14, 2008

(54) COVER STRUCTURE FOR KEY CYLINDER

(75) Inventor: Hironori MIZUNO, Aichi, (JP)

Correspondence Address: SCULLY SCOTT MURPHY & PRESSER, PC, 400 GARDEN CITY PLAZA, SUITE 300, GARDEN CITY, NY, 11530, US

(73) Assignee: KABUSHIKI KAISHA TOKAI RIKA DENKI SEISAKUSHO, Tokyo (JP)

(21) Appl. No.: 12/031,312

(22) Filed: Feb. 14, 2008

(30) Foreign Application Priority Data
Feb. 14, 2007 (JP) 2007-033309

(51) Int. Cl. E05B 17/18

(52) U.S. Cl. 70/455

(57) ABSTRACT

A downsizable cover structure for a key cylinder is in such that the key cylinder 1 having a key slot 1a is provided on the door 2 of a vehicle. The key cylinder 1 is disposed on a cylinder holder 4 to which a cover 6 having a plate-like shutter 5 on one end thereof is slidably attached. When the cover 6 is slid out so as to be retracted from the key cylinder 1, the shutter 5 passes over the key cylinder 1, whereby the key cylinder 1 is exposed on the cylinder holder 4 so that a key 20 may be inserted into the key slot 11a. When the restriction of the shutter 5 is removed after the unlocking/locking operation, the shutter 5 is transferred due to the urging force of a spring in the direction wherein the key cylinder 1 is closed.

The present application is based on Japanese patent application No. 2007-033309 filed on Feb. 14, 2007, the entire contents of which are incorporated herein by reference.

### BACKGROUND OF THE INVENTION

1. Field of the Invention

The invention relates to a cover structure for a key cylinder provided with a shutter for covering the key slot in a key cylinder of a door and the like of a vehicle.

2. Description of the Related Art

In the case that the key slot (key insertion hole) is exposed as it stands in the key cylinder disposed in a door, a trunk room or the like of a vehicle such as an automobile, dust or rainwater invades easily the key slot, and it results in the difficulty in case of inserting the key into the key slot and rotating the key followed to the insertion, or a cause for the corrosion of the key cylinder or the interior of the door.

In this respect, there is proposed a drainage structure constituted in such that the exposed surface of a key cylinder (the surface provided with the key cylinder) is usually covered with a key cover or a shutter, and the key cover or the shutter may be rotated to expose the key slot in the case that the key is inserted thereinto, while a semicircular rib or groove is provided around the key slot of the key cylinder, whereby the invasion of rainwater into the key slot is prevented (for example, see JP-A-H09-105252).

However, according to a conventional key cylinder, since there is provided a key cover or a shutter, the whole length of the key cylinder is extended by the length of the key cover or the shutter and further a shutter opening and closing mechanism is required, and consequently, the downsizing of the key cylinder is difficult.

### SUMMARY OF THE INVENTION

Accordingly, an object of the invention is to provide a cover structure for a key cylinder by which the key cylinder can be downsized.

(1) According to one embodiment of the invention, a cover structure for a key cylinder may comprises a cover for covering a key cylinder provided on the external surface of a vehicle at a home position; a shutter provided integrally or associatingly movably with the cover to cover a key slot of the key cylinder at a predetermined position; and an elastic member for returning the cover to the home position.

In accordance with the above-described constitution, the shutter provided on the cover is transferred together with the cover in connection with the transfer of the cover from the home position to expose the key slot, and on the other hand, when the condition wherein the cover is restricted is excluded, the shutter is returned to the home position together with the cover by means of the functions of the elastic member.

(2) According to another embodiment of the invention, a cover structure for a key cylinder may comprises a shutter for covering a key slot of a key cylinder provided on a vehicle at a home position; a cover journaled rotatably on a common shaft to that of the shutter in which the cover is positioned over the shutter in a superposed mode; and an elastic member for returning the shutter to the home position.

In accordance with the above-described constitution, when the shutter attached rotatably to the key cylinder in such that the cover is positioned over the shutter is rotated in synchronous with the rotation of the cover, the key slot is exposed, and on the other hand, when the condition wherein the cover is restricted is excluded, the shutter is returned to the home position to block up the key cylinder.

### BRIEF DESCRIPTION OF THE DRAWINGS

The invention will be explained in more detail in conjunction with appended drawings, wherein:

FIG. 1 is a perspective view showing the cover structure of a key cylinder according to the first embodiment of the invention;

FIGS. 2A to 2D are perspective views showing covered and uncovered conditions of the cover in the cover structure of FIG. 1 wherein the figures illustrate the respective conditions of the cover structure from the covered state to the unlocked state thereof;

FIGS. 3A, 3B, and 3C are sectional views corresponding to FIGS. 2A to 2D wherein FIG. 3A corresponds to FIG. 2A, FIG. 3B corresponds to FIGS. 2B and 2D, and FIG. 3C corresponds to FIG. 2C, respectively;

FIGS. 4A and 4B show the cover structure for a key cylinder according to the second embodiment of the invention wherein FIG. 4A is a perspective view, and FIG. 4B is a sectional view;

FIGS. 5A, 5B, and 5C show the cover structure of a key cylinder according to the third embodiment of the invention, respectively, wherein FIG. 5A is a perspective view showing the condition in the case that a shutter and the cover are closed, FIG. 5B is a perspective view showing the condition in the case that the shutter is rotated together with the cover, and FIG. 5C is a perspective view in the case that the shutter is closed, while the cover is opened; and

FIGS. 6A, 6B, and 6C show the cover structure of a key cylinder according to the fourth embodiment of the invention, respectively, wherein FIG. 6A is a perspective view showing the condition in the case that a shutter and the cover are closed, FIG. 6B is a perspective view showing the condition in the case that the cover is rotated associatingly with the shutter, and FIG. 6C is a perspective view in the case that the shutter is opened together with the cover.

### DESCRIPTION OF THE PREFERRED EMBODIMENTS

### First Embodiment

Cover Structure of Key Cylinder

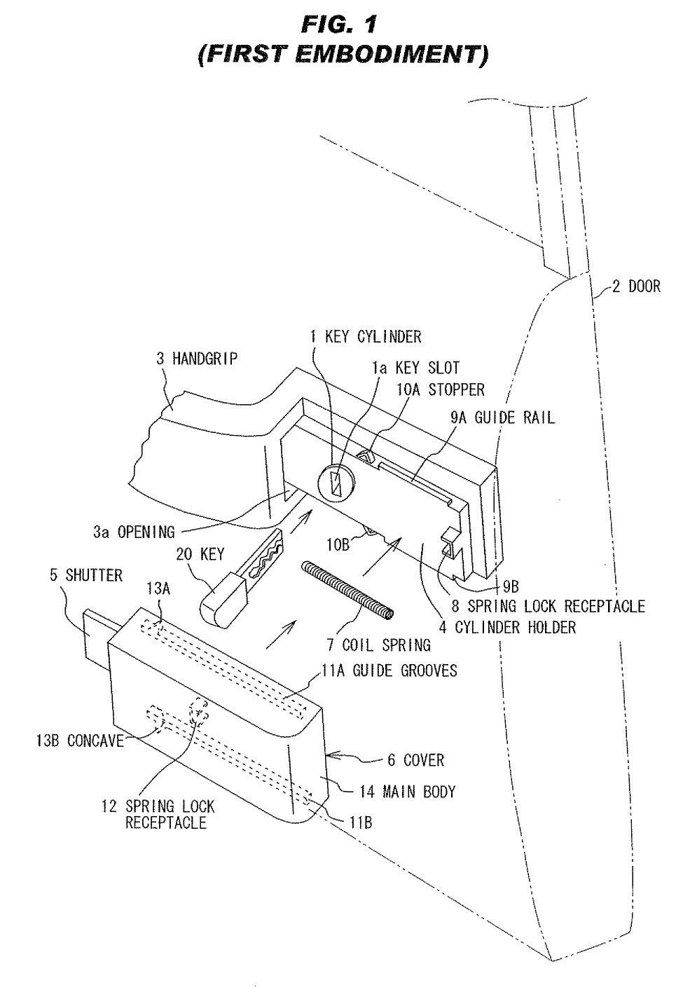

FIG. 1 shows the cover structure of the key cylinder according to the first embodiment of the invention wherein the key cylinder 1 having a key slot 1a into which a key 20 is to be inserted is mounted on a cylinder holder 4 disposed on an end of a handgrip 3 attached to a door 2 of a vehicle such as an automobile. A cover 6 provided with a shutter S is disposed movably along the horizontal direction thereof on the cylinder holder 4.

The cylinder holder 4 has an elongated plate-like shape on one end of which a spring lock receptacle 8 for locking an end of a coil spring (elastic member) 7 is formed. A guide rail 9A and a stopper 10A are provided on the upper side of the cylinder holder 4, while a guide rail 9B and a stopper 10B are provided on the opposed lower side of the cylinder holder wherein each of the stoppers 10A and 10B is prepared by bending a leaf spring into an inverted V-shape.

The cover 6 has a constitution including the shutter 5, guide grooves 11A and 11B fitting to the guide rails 9A and 9B, respectively, a spring lock receptacle 12 for locking the other end of the coil spring 7, and concaves 13A and 13B formed on the inner surface of a main body 14 for retaining the cover 6 on the guide rails 9A and 9B.

The spring lock receptacle 12, the shutter 5, the concaves 13A and 13B, and guide grooves 11A and 11B are united together with the main body 14 by resin-molding these components.

The shutter 5 is provided so as to protrude from one end of the cover 6. The shutter 5 is adapted to be inserted into an opening 3a of the handgrip 3 for containing an end of the cylinder holder 4 in the case that the cover 6 is retained on the cylinder holder 4 in a superposed mode.

Operation of Cover Structure

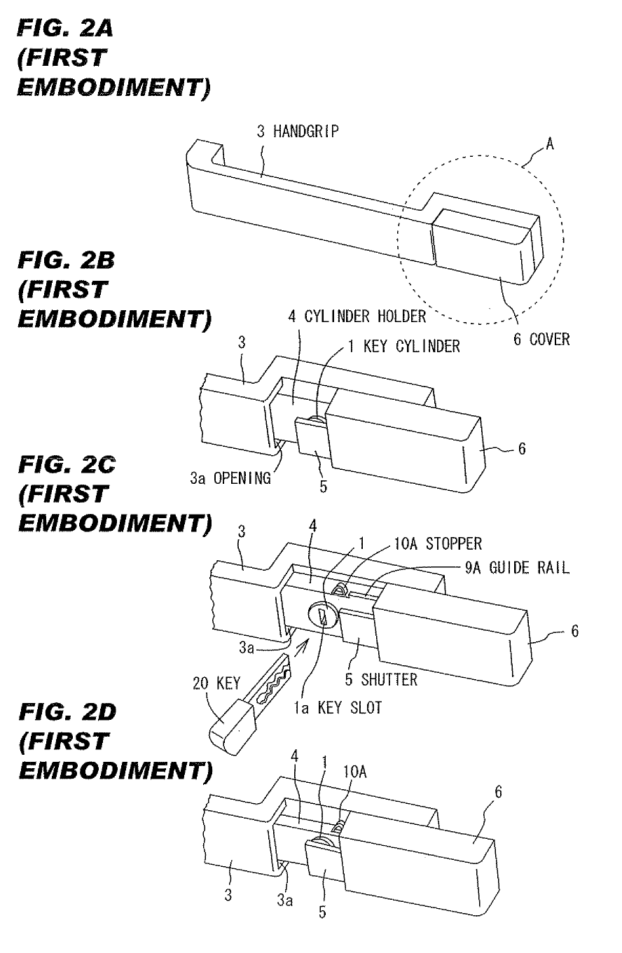

FIGS. 2A to 2D are perspective views showing covered and uncovered conditions of the cover in the cover structure of FIG. 1.

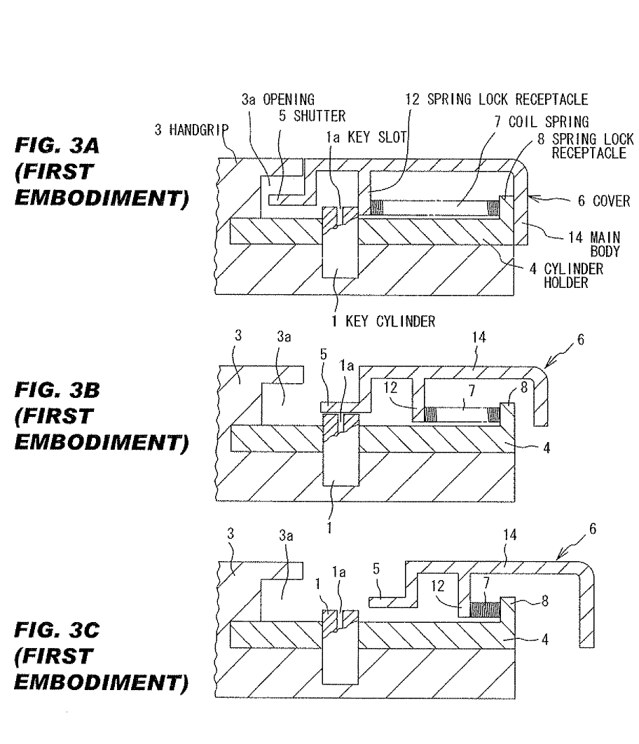

FIGS. 3A, 3B, and 3C are sectional views corresponding to the respective operating conditions in FIGS. 2A to 2D wherein these figures correspond to the enlarged figures of the section A, in FIG. 2A, respectively.

FIG. 2A and FIG. 3A illustrate a condition in the case that the cover 6 is retained on the cylinder holder 4 in the superposed mode wherein the cover 6 is locked up. In this case, the cover 6 is in the home position wherein an end of the main body 14 abuts upon a side of the handgrip 3, because the spring lock receptacle 12 of the main body 14 is urged leftwards by means of the coil spring 7 as shown in FIG. 3A, whereby the interior of the cover 6 is hermetically sealed so that the condition wherein dust and the like are hardly invaded inside the cover 6 is maintained.

Then, when the cover 6 is pulled rightwards partly by a user by the hand, the cover 6 travels from the home position to the right side while guiding guide grooves 11A and 11B by means of the guide rails 9A and 9B, and during this process the shutter 5 gets away from the opening 3a and reaches the position where the stopper 10a engages with the concave 13A as well as the stopper 10b engages with the concave 13B. The position is specifically illustrated in the condition of FIGS. 2B and 3B, respectively. In the condition, the key cylinder 1 is blocked up by the shutter 5 so that the key 20 cannot insert into the key slot 1a.

When the user transfers the cover 6 rightwards further against the tentatively stopped condition of the stoppers 10A and 10B, the shutter 5 passes over the key cylinder 1, whereby the key cylinder 1 is exposed as shown in FIGS. 2C and 3C. Consequently, when the user inserts the key 20 into the key slot 1a and the key 20 is rotated while retaining the cover 6 against the urging force of the coil spring 7, the locking system can be unlocked.

After completing the unlocking operation, when the cover 6 is released from the retention power by the user's fingers, the cover 6 is transferred in the direction of the key cylinder 1 due to the urging force of the coil spring 7 as shown in FIG. 2D, and the stoppers 10A and 90B are fitted in the concaves 13A and 13B to stop the cover 6. In this case, the condition is in such that the key cylinder 1 is covered by the shutter 5 as shown in FIG. 2D and FIG. 3B, and as a consequence, the key slot 1a is prevented from the invasion of dust and the like.

In this situation, when the cover 6 is slid leftwards in the drawing, the stoppers 10A and 10B are released from the concaves 13A and 13B, and the cover 6 returns to the condition shown in FIGS. 2A and 3A due to the urging force of the coil spring 7.

Although the above description relates to the unlocking operation, the locking operation may be made in the same manner as that described above according to the first embodiment.

Advantageous Effects of First Embodiment

According to the first embodiment, the following advantageous effects are obtained.

(1) Since the cover 6 is provided with the shutter 5, the key cylinder 1 is not required to provide the shutter 5 and the opening and closing mechanism therefor, so that the key cylinder 1 may be downsized. As a result, it becomes possible to use a key having a shorter whole length.

(2) Because of the combination of the stoppers 10A, 10B and the concaves 13A, 13B, the shutter 5 blocks up the key cylinder 1 even in the case that a user forgets to shut up the cover 6, so that the key slot 1a can be prevented from the invasion of dust and the like.

(3) Since monolithic molding can be applied to the shutter 5 and the cover 6, the reduction of the number of parts and the manufacturing cost may be achieved.

In the first embodiment, the engagement positions of the stopper 10A and the concave 13A as well as the stopper 10B and the concave 13B are in the condition wherein the shutter 5 superposes the key cylinder 1 as shown in FIG. 2B and 3B. In this respect further concaves into which the stoppers 10A and 10B are to be fitted respectively may be provided on the cover 6 in the condition of the positional relationship shown in FIGS. 2A and 3A. As a consequence, the backlash of the cover 6 can be prevented in the retained condition at the home position thereof.

### Second Embodiment

Cover Structure of Key Cylinder

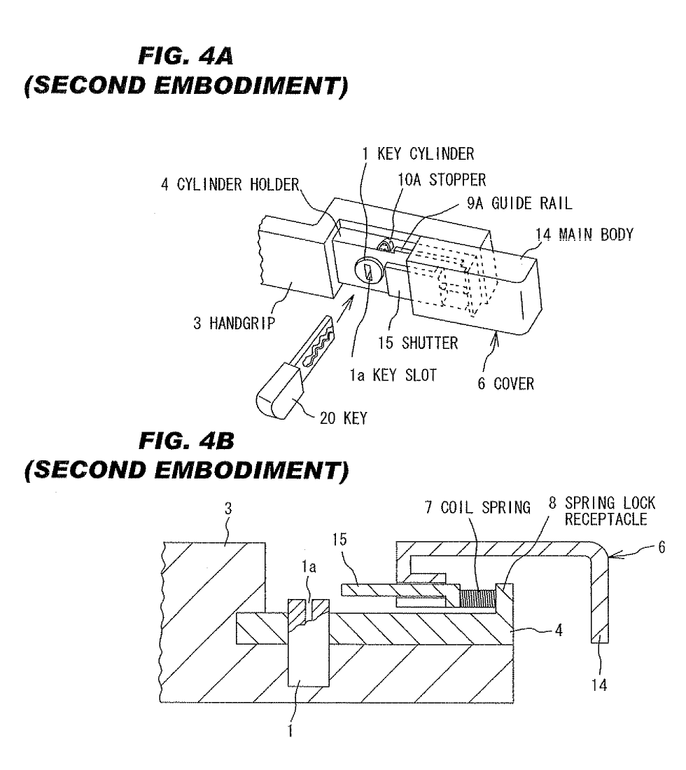

FIGS. 4A and 4B show the cover structure for a key cylinder according to the second embodiment of the invention wherein FIG. 4A is a perspective view, and FIG. 4B is a sectional view. In FIGS. 4A and 4B, stoppers 10A and 10B as well as concaves 13A and 13B are not shown.

The second embodiment is arranged in such that the shutter 5 is not formed integrally with the cover 6 unlike the first embodiment, but a shutter 15 is separately provided from the cover 6 in such a manner that the shutter is attached reciprocately movably to the cover 6, and the shutter 15 is urged by means of a coil spring 7 in the direction of a key cylinder 1. The constitution other than that described above is the same as that of the first embodiment.

In the present embodiment, the spring lock receptacle 12 is removed from the main body 14, and further the opening 3a is removed from the handgrip 3.

Operation of Cover Structure

Next, the unlocking operation of the present embodiment will be described. When the cover 6 positioned in the home position is transferred rightwards in the drawing from the handgrip 3 by a user by the hand, the shutter 15 urged by the coil spring 7 protrudes gradually from the main body 14 during the above-described process.

When the cover 6 is transferred to the position where the stoppers 10A and 10B are fitted into the concaves 13A and 13B, respectively and transferred rightwards further against the urging force of the coil spring 7, the cover 6 is in the condition shown in FIGS. 4A and 4B. In this condition, the shutter 15 passes over the key cylinder 1 50 that the key cylinder 1 is exposed. Accordingly, when a key 20 is inserted into the key slot 1a of the key cylinder 1 and rotated while retaining the cover 6 by the hand against the urging force of the coil spring 7, the key system can be unlocked.

After completing the unlocking operation, when the user gets the hand off from the cover 6, the cover 6 travels in the direction of the key cylinder 1 due to the urging force of the coil spring 7, so that the stoppers 10A and 10B fit into the concaves 13A and 13B, respectively, to stop the cover 6.

Furthermore, when the cover 6 is forcibly transferred leftwards in FIGS. 4A and 4B, the stoppers 10A and 10B are released from the concaves 13A and 13B, respectively, and the cover 6 travels leftwards due to the urging force of the coil spring 7. During the process, the shutter 15 is contained gradually in the main body 14, and the cover 6 superposes finally the cylinder holder 4, whereby the key cylinder 1 is blocked up by the cover 6.

The above description relates to the unlocking operation, but the locking operation may be made in the same manner as that described above.

According to the second embodiment, since the opening 3a is not provided on the handgrip 3, the interior of the handgrip 3 can be prevented from the invasion of dust and the like. The advantageous effects other than that described above are the same as that of the first embodiment.

### Third Embodiment

Cover Structure of Key Cylinder

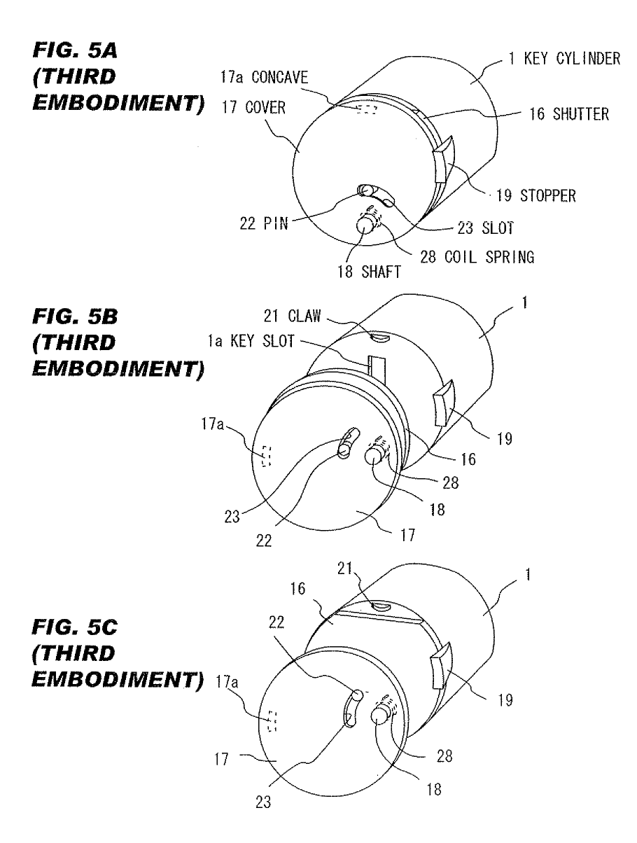

FIGS. 5A, 5B, and 5C show the cover structure of a key cylinder according to the third embodiment of the invention, respectively, wherein FIG. 5A is a perspective view showing the condition in the case that a shutter and the cover are closed, FIG. 5B is a perspective view showing the condition in the case that the shutter is rotated together with the cover, and FIG. 5C is a perspective view in the case that the shutter is closed, while the cover is opened. In FIGS. 5A, 5B, and 5C, the door 2, the handgrip 3, and the cylinder holder 4 shown in FIG. 1 are not shown.

The third embodiment is arranged in such that a shutter 16 and a cover 17 the diameters of them are the same as that of a key cylinder 1 are journaled rotatably on a shaft 18 on the surface of the key cylinder 1 (key insertion surface), and further the shutter 16 is urged in the clockwise direction by means of a coil spring (elastic member) 28 attached to the shaft 18.

In the present embodiment, although the cover 6 is not required, such a cover having the constitution wherein the shutter 5 is removed from the cover of the first embodiment shown in FIGS. 3A, 3B, and 3C may be used, if it is provided. Moreover, the constitution of the handgrip 3 does not contain the opening 3a.

A key slot 1a is provided on the key cylinder 1, a stopper 19 for restricting the rotation of the shutter 16 and the cover 17 are provided on the right side of the key cylinder 1, and further a claw 21 for preventing the transverse movement of the cover 17 is provided on the surface of the upper part of the key cylinder 1 in FIGS. 5A, 5B, and 5C.

A part of the circumference of the shutter 16 is cut away so as not to be in contact with the claw 21 in the case that the cover 17 is closed as shown in FIG. 5C, and further a pin is established near at the shaft 18.

The cover 17 having a concave 17a for fitting to the claw 21 and a circular arc slot 23 for guiding the pin 22 is journaled on the shaft 18 so as to rotate independently from the shutter 16.

Operation of Cover Structure

Next, the unlocking operation of the present embodiment will be described. First, a user pulls up the cover 17 from the handgrip 3 in the case that the key cylinder 1 is provided with the cover 17.

Then, the user pushes the shutter 16 and the cover 17 centering on the shaft 18 from their home position shown in FIG. 5A in the counterclockwise direction to be in the condition shown in FIG. 5B. From this condition, the user rotates further the shutter 16 and the cover 17 in the counterclockwise direction, so that the whole key slot 1a is exposed.

Otherwise when the user pushes the cover 17 in the counterclockwise direction, the pin 22 moves in the slot 23. At the time when the pin 22 moves up to an end of the slot 23, the cover 17 rotates together with the shutter 16 at an angle of about 90°. When the cover 17 is continued to rotate as it stands, the whole key slot 1a is exposed.

Then, the user inserts a key 20 into the key slot 1a of the key cylinder 1 to rotate the key 20 while maintaining the exposed condition of the key slot 1a, the locking system can be unlocked.

After completing the unlocking operation, when the user releases the shutter 16 and the cover 17 by taking off user's fingers therefrom, the shutter 16 rotates in the clockwise direction due to the urging force of the coil spring 28. The shutter 16 stops at the time when the side of the shutter 16 abuts upon the stopper 19 to be in the condition shown in FIG. 5C.

On the other hand, when the pin 22 of the shutter 16 travels in the long slot 23 in accordance with the rotation of the shutter 16, the cover 17 is rotated as a consequence of the pull force of the pin 22 to be in the condition shown in FIG. 5C, and the cover 17 stops. In this condition, although the cover 17 is in a half-closed condition, dust and the like does not invade the key slot 1a, since the shutter 16 blocks up the key slot 1a.

Then, when the cover 17 is rotated from the condition shown in FIG. 5C by the user's hand in the clockwise direction, the side of the cover 17 abuts upon the topper 19 to be in the condition shown in FIG. 5A, whereby the surface of the key cylinder 1 is closed by the shutter 16 and the cover 17, and further the concave 17a of the cover 17 is fitted to the claw 21 so that the cover 17 is secured.

Although the above description concerns to an unlocking operation, a locking operation can be made in accordance with the same manner as that described above.

Advantageous Effects of Third Embodiment

According to the third embodiment, the following advantages are obtained.

(1) Due to such constitution that the disk-shaped shutter 16 and cover 17 are attached to the key cylinder 1 by means of the shaft 18, the whole length of the key cylinder 1 may be reduced, and consequently the key cylinder 1 can be downsized.

(2) Since the shutter 16 and the cover 17 are provided rotatably on the surface of the key cylinder 1, the key slot 1a is closed by the shutter 16 so that the invasion of dust and the like into the key slot 1a can be prevented, even if the user forgets to close the cover 17.

(3) The shutter 16 is provided with the pin 22, while the cover 17 is provided with the slot 23, whereby either of the shutter 16 and the cover 17 may be rotated in synchronous with the other.

### Fourth Embodiment

Cover Structure for Key Cylinder

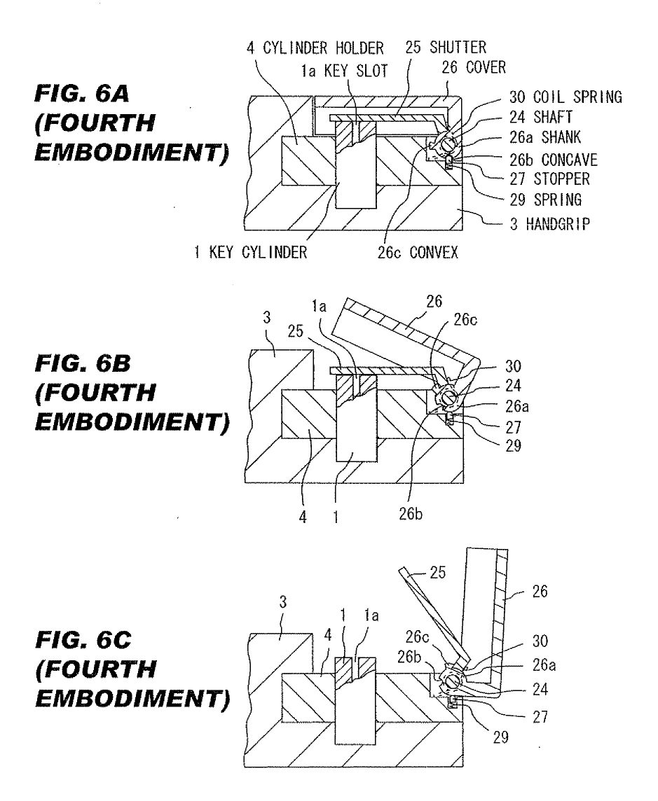

FIGS. 6A, 6B, and 6C show the cover structure of a key cylinder according to the fourth embodiment of the invention, respectively, wherein FIG. 6A is a perspective view showing the condition in the case that a shutter and the cover are closed, FIG. 6B is a perspective view showing the condition in the case that the shutter is rotated associatingly with the cover, and FIG. 6C is a perspective view in the case that the shutter is opened together with the cover. The fourth embodiment is constituted in such that a shutter 25 and a cover 26 are journaled on a shaft 24 disposed on the cylinder holder 4 in the second embodiment, and the other constitution is the same as that of the second embodiment.

In the present embodiment, the spring lock receptacle 8, the guide rails 9A and 9B, and the stoppers 10A and 10B are removed from the cylinder holder 4 of the second embodiment.

As shown in FIG. 6A, the shutter 25 and the cover 26 are disposed in a condition (at the home position) wherein they are superposed vertically one another.

The shutter 25 has a substantially L-shaped section, the long side of which is in plate-like, the extreme end of which is located so as to cover a key cylinder 1, and which is urged by means of a coil spring (elastic member) 30 in the counter-clockwise direction of FIGS. 6A, 6B, and 6C.

The cover 26 has an L-shaped section, and the whole profile of which is a box shape. Moreover, a concave 26b is provided on a shank 26a of the cover 26 to which the shaft 24 is internally fitted, and further a convex 26c for abutting upon the inside of a short side of the shutter 25 is provided. The cover 26 has no elastic member such as a spring.

In the cylinder holder 4, a stopper 27 is liftably disposed on the under side of the shaft 24, and the stopper 27 is urged upwards by means of a spring 29.

Operation of Cover Structure

Next, the unlocking operation of the present embodiment will be described. First, when a user pulls up the extreme end of the cover 26 by the hand from the home position thereof shown in FIG. 6A, the stopper 27 is released from the concave 26b of the cover 26, whereby the cover 26 is easily rotated so that the cover 26 retains the condition, even if the user releases the cover 26 by taking off users' fingers therefrom, and the condition is in that shown in FIG. 6B.

From this condition, when the stopper 27 is further rotated in the clockwise direction of FIG. 6B, the convex 26c of the cover 26 abuts upon the inside of the shutter 25, whereby the rotation of the cover 26 results in the association rotation of the shutter 25 in the clockwise direction, and finally the cover 26 and the shutter 27 are in the condition shown in FIG. 6C.

In FIG. 6C, when the user inserts the key shown in FIG. 1 into the key slot 1a of a key cylinder 1 while retaining the condition of the cover 26 and rotates the key 20, the locking system can be unlocked.

After completing the unlocking operation, when the user releases the cover 26 by taking off the users' fingers from the cover 26, the shutter 25 rotates in the counterclockwise direction of FIG. 6C due to the urging force of a coil spring 30 provided on the shutter 25, and further the cover 26 rotates together with the shutter 25 up to the position shown in FIG. 6B as a result of urging the convex 26c in the counterclockwise direction. In this condition, since the key cylinder 1 is blocked up by the shutter 25, the invasion of dust and the like into the key slot 1a is prevented.

When the cover 26 is further rotated herein in the counterclockwise direction and the cover 26 is allowed to be in parallel to the surface of the cylinder holder 4, they are in the condition shown in FIG. 6A. In this case, the stopper 27 fits into the concave 26b; the cover 26 is locked, whereby the occurrence of rattling is suppressed.

Although the above description concerns the unlocking operation, the locking operation can be made also by the same manner as that described above.

Advantageous Effects of Fourth Embodiment

According to the fourth embodiment, the following advantages are obtained.

(1) Since the shutter 25 is provided inside the cover 26, there are no need of providing the shutter 25 as well as the opening and closing mechanism therefor on the key cylinder 1 so that the key cylinder 1 may be downsized. As a consequence, it becomes possible to adopt a key having the shorter whole length.

(2) Even if a user forgets to close the cover 26, the shutter 25 blocks up the key cylinder 1 so that the invasion of dust and the like into the key slot 1a can be prevented.

Other Embodiments

The invention is not limited to the above-described respective embodiments, but a variety of modifications may be made so far as the subject matter of the invention is not altered. For example, the components of the respective embodiments may be combined arbitrarily with each other.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

What is claimed is:

1. A cover structure for a key cylinder, comprising:
a cover for covering a key cylinder provided on the external surface of a vehicle at a home position;
a shutter provided integrally or associatingly movably with the cover to cover a key slot of the key cylinder at a predetermined position; and
an elastic member for returning the cover to the home position.

2. The cover structure according to claim 1, wherein:
the shutter is in a condition in which the shutter covers the key cylinder even in the case that the cover is not in the condition in which the cover covers the key cylinder.

3. The cover structure according to claim 1, wherein:
the shutter is provided so as to protrude from an end of the cover.

4. The cover structure according to claim 1, wherein:
the elastic member is a coil spring.

5. The cover structure according to claim 4, wherein:
a cylinder holder on which the key cylinder is provided has an elongated plate-like shape on one end of which a spring lock receptacle for locking an end of the coil spring is formed, guide rails and stoppers are provided on the upper and lower opposed sides of the cylinder holder, respectively, in which each of the stoppers is prepared by bending a leaf spring into an inverted V-shape.

6. The cover structure according to claim 5, wherein:
the cover has the shutter, guide grooves fitting to the guide rails, respectively, a spring lock receptacle for locking the other end of the coil spring, and concaves formed on the inner surface of a main body for fitting into the guide rails.

7. The cover structure according to claim 6, wherein:
the spring lock receptacle, the shutter, the concaves, and guide grooves are united together with the main body by means of resin-molding.

8. The cover structure according to claim 4, wherein:
the shutter is attached reciprocately movably to the cover in such a manner that the shutter is urged by means of the coil spring in the direction of the key cylinder.

9. A cover structure for a key cylinder, comprising:
a shutter for covering a key slot of a key cylinder provided on a vehicle at a home position;
a cover journaled rotatably on a common shaft to that of the shutter in which the cover is positioned over the shutter in a superposed mode; and
an elastic member for returning the shutter to the home position.

10. The cover structure according to claim 9, wherein:
the shutter is in a condition in which the shutter covers the key cylinder even in the case that the cover is not in the condition in which the cover covers the key cylinder.

11. The cover structure according to claim 9, wherein:
the elastic member is a coil spring.

12. The cover structure according to claim 9, wherein:
the shutter and the cover have the same diameter as that of the key cylinder.

13. The cover structure according to claim 9, wherein:
the key cylinder is provided with a stopper for restricting the rotation of the shutter and the cover on the side thereof.

14. The cover structure according to claim 9, wherein:
the key cylinder is provided with a claw fitting to a concave of the cover on the upper part of the surface thereof to prevent the transverse movement of the cover.

15. The cover structure according to claim 14, wherein:
a part of the circumference of the shutter is cut away so as not to be in contact with the claw in the case that the cover is closed.

16. The cover structure according to claim 9, wherein:
the shutter and the cover are disposed in a condition in which they are in a vertically superposed mode.

17. The cover structure according to claim 9, wherein:
the shutter has a substantially L-shaped section, the long side of which is in plate-like, the extreme end of which is located so as to cover a key cylinder.

18. The cover structure according to claim 9, wherein:
the cover has an L-shaped section, and the whole profile of which is a box shape.

19. The cover structure according to claim 9, wherein:
the cover is provided with a concave, into which the stopper is fitted, on a shank of the cover to which the shaft is internally fitted, whereby the cover is locked.

20. The cover structure according to claim 19, wherein:
the concave provided on the shank of the cover to which the shaft is internally fitted is forced due to the urging force of the coil spring in a predetermined direction, whereby the cover rotates together with the shutter up to a predetermined position.
